(19) United States
(12) Patent Application Publication
(10) Pub. No.: US 2026/0360083 A1
(43) Pub. Date: Nov. 12, 2026

(54) THREE-DIMENSIONAL MODEL GENERATION METHOD AND SYSTEM, BASED ON LIGHTWEIGHT GLASS CONTAINER

(71) Applicant: SHANDONG JINGYAO GLASS GROUP CO., LTD., Linyi (CN)

(72) Inventors: Weizhao Tang, Linyi (CN); Cundong Gao, Linyi (CN); Weidong Wang, Linyi (CN); Xugang Qiu, Linyi (CN); Cheng Chi, Linyi (CN); Xiaoli Liu, Linyi (CN)

(21) Appl. No.: 19/570,436

(22) Filed: Mar. 18, 2026

(30) Foreign Application Priority Data
May 9, 2025 (CN) 202510594166.9

(51) Int. Cl. G06T 17/20; G06T 15/50

(52) U.S. Cl. CPC G06T 17/20; G06T 15/50

(57) ABSTRACT

The present disclosure relates to a technical field of model construction, in particular to a three-dimensional model generation method and system, based on lightweight glass container. The method includes the following steps: collecting information of the lightweight glass container by using a preset multi-modal scanning sensor, collecting multi-view visible light images, depth information and structured light projection data, and constructing a standard multi-view point cloud data set; performing multi-modal fusion based on the standard multi-view point cloud data set to obtain multi-modal fusion data of the glass container; performing thin-wall judgment on the multi-modal fusion data of the glass container, and performing thin-wall structure repair to obtain a high-integrity three-dimensional point cloud model.

### CROSS-REFERENCE TO RELATED APPLICATIONS

This application claims priority benefits to Chinese Patent Application No. 202510594166.9, filed May 9, 2025, the contents of which are incorporated herein by reference.

### FIELD OF TECHNOLOGY

The present disclosure relates to a technical field of model construction, and more particularly, to a three-dimensional model generation method and system, based on lightweight glass container.

### BACKGROUND OF THE INVENTION

In the data acquisition stage, traditional three-dimensional modeling methods often rely on single-modal data sources (such as single-view images or basic depth information), making it difficult to fully capture the complex curvature changes and thin-walled structures on the surface of glass container; especially at positions with obvious local geometric features where reflection and occlusion are prone to occur, such as bottle necks, bottle shoulders and bottle bottoms, point cloud data often suffers from missing and degradation phenomena, resulting in limited precision of subsequent models. Secondly, the existing mesh reconstruction and optimization methods are mostly based on general algorithms, lacking a modeling mechanism for the regional geometric characteristics (such as non-uniform curved surface structures) and error accumulation characteristics of glass container, and it is often difficult to strike a balance between precision and complexity; the generated mesh models have problems such as topological fractures, large edge folding errors and frequent non-manifold structures, which limit the usability and stability of the models in industrial applications. In addition, in the current modeling process, the processing of model materials mostly stays at the level of unified texture mapping or rough value assignment, failing to carry out targeted expression according to the optical properties of different structural regions, resulting in insufficient realism of the models in simulation, evaluation or rendering links, especially limited precision in simulating the transparency, glossiness and texture details of glass surfaces. Furthermore, the existing systems mostly lack a dynamic evaluation mechanism for the modeling process, unable to effectively monitor and feed back problems such as point cloud missing, mesh degradation and error diffusion occurring in modeling, and it is difficult to form a traceable and optimizable closed-loop modeling process, thus reducing the adaptability and robustness of the models in multi-scenario deployment.

### SUMMARY OF THE INVENTION

Based on this, it is necessary to provide a three-dimensional model generation method and system based on lightweight glass container to solve at least one of the above technical problems.

To achieve the above purpose, a three-dimensional model generation method, based on lightweight glass container, the method includes the following steps:

Step S1: collecting information of the lightweight glass container by using a preset multi-modal scanning sensor; collecting multi-view visible light images, depth information and structured light projection data, and constructing a standard multi-view point cloud data set;

Step S2: performing a multi-modal fusion to the standard multi-view point cloud data set to obtain multi-modal fusion data of the glass container; performing a thin-wall judgment on the multi-modal fusion data of the glass container, and performing a thin-wall structure repairment to obtain a high-integrity three-dimensional point cloud model;

Step S3: performing a lightweight mesh optimization to the high-integrity three-dimensional point cloud model to obtain a low-complexity three-dimensional mesh model; performing a global error compensation for container casting and melting to the low-complexity three-dimensional mesh model to obtain container casting and melting compensation data; performing a material optimization of glass contour to the low-complexity three-dimensional mesh model to obtain curved surface partitioning feature data of the glass container; performing a model lightweight optimization to the low-complexity three-dimensional mesh model by using the container casting and melting compensation data and the curved surface partitioning feature data of the glass container, thereby obtaining a high-precision and lightweight three-dimensional model of the glass container;

Step S4: performing a glass surface texture evaluation according to the high-precision and lightweight three-dimensional model of the glass container to obtain glass model texture evaluation data; performing a model generation process evaluation according to the high-precision and lightweight three-dimensional model of the glass container to obtain glass model generation process evaluation data; constructing a full-process path from the glass model texture evaluation data and the glass model generation process evaluation data, and performing a weak point marking to obtain a three-dimensional model construction report of the glass container.

The beneficial effects of the present invention lie in that by deploying a multi-modal scanning system, collecting data including multi-view visible light images, depth information and structured light projection data, and constructing a standard multi-view point cloud data set, abundant three-dimensional information can be obtained, which lays a foundation for subsequent data processing and model construction. Performing multi-modal data fusion and thin-wall structure repair based on the standard multi-view point cloud data set can effectively eliminate differences and errors among data, reduce the problem of data inconsistency caused by scanning accuracy limitations, repair thin-wall structure areas at the same time, further improve the integrity of the point cloud model, and provide more accurate and reliable basic data for subsequent mesh optimization and refined processing. In Step S3, performing lightweight mesh optimization on the high-integrity three-dimensional point cloud model to generate a low-complexity three-dimensional mesh model effectively reduces the computational complexity of the model and improves the processing speed and efficiency of the model. Further global error compensation and material optimization enable the finally generated three-dimensional model of the glass container to have high precision, ensuring accurate simulation of physical properties and appearance in practical applications. In Step S4, performing surface texture evaluation and model generation process evaluation on the high-precision and lightweight three-dimensional model of the glass container can conduct detailed analysis on the texture details of the model and potential errors in the generation process in a data-driven manner, so as to obtain glass model texture evaluation data and generation process evaluation data. These evaluation data play an important role in the links of full-process path construction and weak point marking, can locate weak areas or errors existing in the model, and further generate a detailed three-dimensional model construction report of the glass container, providing strong data support for subsequent model optimization. Overall, the technical process improves the precision and reliability of the three-dimensional model through effective fusion and evaluation optimization of multi-modal data, ensures high-quality modeling and accurate application of the glass container, and especially provides an important basis for the optimization of surface texture, geometric structure and material characteristics. Therefore, the present invention solves the problems of low structural reconstruction accuracy, large transparent material errors and lack of process evaluation in traditional glass container modeling through multi-modal data fusion, joint geometry and optical optimization and multi-scale path evaluation mechanism, and improves the geometric fidelity, material restoration degree and full-process construction controllability of the three-dimensional model.

Preferably, step S1 includes the following steps:
Step S11: deploying a high-resolution visible light camera with a resolution of more than 20 million pixels and a frame rate of 30 fps and a structured light projector with a wavelength of 450-650 nm and a fringe density of 0.1 mm/line on an annular scanning track, and collecting multi-angle visible light image data and multi-angle structured light projection data at a spatial sampling interval of 0.5 mm;
Step S12: deploying a ToF depth sensor with an accuracy of 0.1 mm and a sampling frequency of 20 Hz in a scanning system; collecting depth information of the glass container, and obtaining glass projection distortion parameters;
Step S13: performing a highlight suppression on the multi-angle visible light image data and the multi-angle structured light projection data, and performing refraction compensation by using the glass projection distortion parameters to obtain a glass noise reduction multi-source data set;
Step S14: performing spatial alignment on the glass noise reduction multi-source data set to generate a standard multi-view point cloud data set.

The present invention can obtain more detailed and high-quality three-dimensional data by deploying a high-resolution visible light camera and a structured light projector and collecting multi-angle visible light images and structured light projection data at a small spatial sampling interval (0.5 mm), ensuring the complementarity and comprehensiveness of information obtained from different viewing angles. These high-precision data provide a rich source of raw data for subsequent three-dimensional modeling and repair. In Step S12, the deployment of the ToF depth sensor ensures the high-precision collection of depth data with an accuracy of 0.1 mm and a sampling frequency of 20 Hz, which provides a more accurate measurement of the depth information of the glass container and further improves the spatial resolution and geometric accuracy of the model. In addition, the glass projection distortion parameters provided by the depth sensor play an important role in subsequent refraction compensation, which can effectively reduce errors caused by refraction on the glass surface and ensure the accuracy of the point cloud data. In Step S13, performing highlight suppression on the multi-angle image data and structured light data further reduces noise caused by ambient light interference or surface reflection, improving data quality. At the same time, refraction compensation with the help of the glass projection distortion parameters effectively corrects geometric distortion caused by optical refraction, making the multi-source data set more real and accurate. Finally, in Step S14, performing spatial alignment on the noise-reduced data set to generate a standard multi-view point cloud data set ensures the spatial consistency and precise alignment of the data, laying a solid foundation for subsequent three-dimensional reconstruction and analysis. In summary, this series of steps greatly improves data quality through high-precision data collection, noise suppression and distortion compensation, providing accurate and reliable basic data for subsequent three-dimensional modeling, repair and optimization, thus ensuring the efficiency and accuracy of the entire system in the process of glass container modeling.

Preferably, the performance of multi-modal data fusion based on the standard multi-view point cloud data set in step S2 includes:
Acquiring a glass material parameter library;
Simulating the refraction, reflection and scattering behaviors of light on the glass surface by using the glass material parameter library to generate an optical characteristic mapping table;
Performing point-to-point binding on the optical characteristic mapping table and the standard multi-view point cloud data set to generate physically enhanced point cloud data;
Inputting the physically enhanced point cloud data into a differentiable renderer to perform L1 loss and SSIM loss calculations between a rendered image and a real visible light image, so as to generate multi-modal fusion data of the glass container, wherein the weights of the L1 loss and the SSIM loss are 0.7 and 0.3 respectively.

The present invention significantly improves the precision and realism of three-dimensional modeling of glass container through physical enhancement and image calibration steps. In the process of acquiring a glass material parameter library and using the library to simulate the refraction, reflection and scattering behaviors of light on the glass surface, the optical characteristics of glass materials can be accurately captured, which provides sufficient physical basis for the subsequent generation of an optical characteristic mapping table. The optical characteristic mapping table provides important optical parameters for accurate three-dimensional modeling by describing the interaction between light and the glass surface in detail, ensuring that the interaction between light and the glass surface can be fully simulated in the rendering process to reflect the complex optical behaviors of the glass surface in the real world. When performing point-to-point binding between the optical characteristic mapping table and the standard multi-view point cloud data set, a richer point cloud data set with physical basis can be obtained through such fine combination, so that the generated point cloud data is not only accurate in spatial structure, but also has higher authenticity in physical attributes. The physically enhanced point cloud data is further input into a differentiable renderer to compare the rendered image with the real visible light image. Through the calculation of L1 loss and SSIM loss, not only the structural and detail similarity between the rendered image and the real image is guaranteed, but also different loss types are balanced by adjusting the weights of the loss function (0.7 and 0.3), which further optimizes the quality of the rendering result. The combination of L1 loss and SSIM loss ensures that the pixel difference and structural similarity of the image are balanced, so that the finally generated multi-modal fusion data of the glass container can take into account both the detail restoration of the image and the stability of the structure, significantly improving the accuracy and authenticity of the point cloud data. This process not only improves the influence of optical characteristics on the three-dimensional model, but also effectively improves the data quality in the rendering process, thus providing higher quality data support for subsequent three-dimensional modeling and virtual reality applications.

Preferably, the performance of thin-wall structure repair in step S2 includes:
Performing prediction for thin-wall areas less than 2 mm based on the multi-modal fusion data of the glass container to generate a predicted glass thickness distribution;
Inputting the predicted glass thickness distribution as a constraint condition into a Poisson surface reconstruction algorithm, wherein the depth of the Poisson surface reconstruction algorithm is 10 and the weight is 0.5, to obtain vertex density data of the glass curved surface mesh;
Performing iterative Poisson reconstruction parameter adjustment on the vertex density data of the glass curved surface mesh, and performing three-dimensional mesh model construction to obtain a high-integrity three-dimensional point cloud model.

Preferably, the performance of lightweight mesh optimization based on the high-integrity three-dimensional point cloud model in step S3 includes:
Performing Gaussian curvature threshold judgment and sensitivity analysis on the high-integrity three-dimensional point cloud model to obtain sensitivity analysis data of the three-dimensional point cloud model, wherein the Gaussian curvature threshold is less than 0.01/mm²;
Performing scratch and seam area identification by using the sensitivity analysis data of the three-dimensional point cloud model, and marking the data as physical characteristic exemption data;
Performing mesh reduction on the high-integrity three-dimensional point cloud model based on the physical characteristic exemption data to obtain a mesh area reduction model, wherein the reduction rate of mesh reduction is 20%-50%;
Performing mesh topology optimization on the mesh area reduction model to obtain a low-complexity three-dimensional mesh model.

The present invention effectively improves the processing efficiency and precision of the high-integrity three-dimensional point cloud model, reduces the consumption of computing and storage resources, and optimizes the subsequent modeling and analysis process through Gaussian curvature analysis, sensitivity analysis, scratch and seam area identification, mesh reduction and topology optimization. First, by performing Gaussian curvature threshold judgment on the high-integrity three-dimensional point cloud model, areas with small surface curvature changes can be effectively identified, and these areas usually correspond to flat or nearly flat parts of the geometric structure. Setting the Gaussian curvature threshold to be less than 0.01 helps distinguish areas with significant detail changes from relatively flat areas, thereby reducing excessive attention to unimportant areas in subsequent processing. Sensitivity analysis further refines the understanding of the performance of the three-dimensional point cloud model under different conditions, helps identify parts of the model that are more sensitive to changes in physical characteristics, and the generated sensitivity analysis data provides a clear basis for subsequent model optimization. On this basis, scratch and seam area identification can be performed by using the sensitivity analysis data, and these areas are marked as physical characteristic exemption data, which means that they do not need further processing or optimization. This helps reduce unnecessary computation and optimization, and improves overall processing efficiency. Next, mesh reduction is performed on the three-dimensional point cloud model based on the physical characteristic exemption data, and controlling the reduction rate within the range of 20%-50% can greatly reduce the complexity of the model without significantly losing the key features of the model. Finally, after mesh reduction, mesh topology optimization is continued, and the processing efficiency and computing performance of the model are further improved by adjusting the connectivity and stability of the mesh structure. The finally obtained low-complexity three-dimensional mesh model retains the key geometric information of the model and reduces the requirements for computing and storage, which is of great significance for subsequent visualization, analysis and application. Through this series of optimization steps, the precision, efficiency and operability of the three-dimensional point cloud model in practical applications are ultimately improved, ensuring the stability and effectiveness in complex data processing.

Preferably, the performance of mesh topology optimization on the mesh area reduction model in step S3 includes:
Performing edge collapse error optimization on the mesh area reduction model to obtain edge collapse optimization data;
Performing mesh manifold integrity verification according to the edge collapse optimization data to obtain glass manifold integrity data;
Performing mesh topology structure construction by using the glass manifold integrity data, and performing non-manifold edge and isolated vertex verification by using Euler's formula to obtain a glass container mesh topology structure;
Performing low-complexity optimization on the glass container mesh topology structure and the mesh area reduction model to obtain a low-complexity three-dimensional mesh model.

The present invention improves the geometric topological stability and overall structural integrity of the three-dimensional mesh model through edge collapse error optimization and manifold integrity verification mechanism, and significantly reduces the number of patches and data complexity of the model through low-complexity optimization means. At the data level, edge collapse error optimization is first performed on the mesh area reduction model. On the premise of keeping the basic geometric shape unchanged, edge pairs with the smallest error are selected for collapse processing, thereby reducing redundant edges and faces and improving mesh simplification efficiency. Each collapsible edge is evaluated through an error function, the collapse priority is determined, and edge collapse optimization data is generated, which includes local topological change information corresponding to edge collapse and its corresponding error value. Then, mesh manifold integrity verification is performed according to the edge collapse optimization data to ensure that edge collapse will not damage the manifold structure of the original mesh, thereby generating glass manifold integrity data, which is used to record the integrity state of the mesh in terms of topological structure continuity, normal consistency and edge-face-vertex relationship. On the basis of verifying manifoldness, mesh topology structure construction is carried out by using the integrity data, and Euler's formula V−E+F=2 is introduced to screen and correct non-manifold edges and isolated vertices, further ensuring that the finally generated glass container mesh topology structure meets the geometric modeling constraint requirements in terms of topological closure and structural connectivity. Subsequently, low-complexity optimization is carried out by combining the reduced mesh area model with the above-mentioned mesh topology structure. Patch merging, vertex relocation and triangle reconstruction are performed on the premise of maintaining the main geometric features of the model, which significantly reduces the total number of vertices, edges and faces, and generates a low-complexity three-dimensional mesh model with small data volume, low redundancy and clear structure. This process realizes the effective integration of three-dimensional geometric model structure optimization, data compression and precision control from error data extraction to topological verification and then to low-complexity generation, providing a high-precision and lightweight data basis for subsequent rendering, simulation or analysis.

Preferably, the performance of global error compensation for container casting and melting on the low-complexity three-dimensional mesh model in step S3 includes:
Acquiring measured data of the glass container;
Performing geometric node extraction of the glass container based on the low-complexity three-dimensional mesh model;
Performing node error analysis by using the geometric node extraction of the glass container and the measured data of the glass container to obtain node comparison and analysis data of the glass container;
Performing deviation compensation according to the node comparison and analysis data of the glass container to obtain container casting and melting compensation data.

The present invention improves the performance of the three-dimensional mesh model in terms of geometric accuracy and material mapping consistency through quantitative comparative analysis of geometric node errors and a deviation compensation mechanism, and finally generates a three-dimensional model of the glass container with high fidelity and low complexity. Specifically, the measured data of the glass container obtained first is generally derived from laser scanning, structured light or coordinate measuring machines, and its data format exists in the form of point coordinate sets or boundary feature sets, serving as a real physical benchmark. Subsequently, geometric node extraction is performed on the low-complexity three-dimensional mesh model to obtain the topological position and spatial relationship information of each key structural point of the model. By performing point-by-point matching and spatial difference calculation between the geometric node data and the measured data, a set of node error vectors can be formed, constituting node comparison and analysis data of the glass container. The data includes error indicators such as the Euclidean distance, normal offset angle and adjacent edge length deviation between each key node and the measured point in the three-dimensional space. Inverse transformation and interpolation adjustment of spatial positions are performed according to the error vectors to construct a compensation offset matrix, thereby completing the generation of container casting and melting compensation data. The error balancing data not only includes geometric correction vectors, but also realizes local limitation of error propagation range and boundary reconstruction of material mapping areas through fusion with the original mesh structure. On this basis, the error balancing data is further used to optimize the material of the low-complexity three-dimensional mesh model, and different material attribute parameters are assigned according to the error residual intensity of each area, so as to avoid inconsistent light, reflection or transparency caused by geometric deviation. The optimization process comprehensively considers structural matching accuracy, material parameter distribution and visual realism, so that the finally constructed high-precision and lightweight three-dimensional model of the glass container retains a low-polygon structure while having good spatial reconstruction accuracy and consistent material performance, significantly enhancing the engineering adaptability and subsequent visualization capability of the model.

Preferably, the performance of material optimization on the glass contour of the low-complexity three-dimensional mesh model includes:
Performing curved surface block division on a bottle neck area, a bottle shoulder area, a bottle body area and a bottle bottom area by using the container casting and melting compensation data to obtain curved surface block feature data of the glass container; performing mesh model alignment on the curved surface block feature data of the glass container to obtain a high-precision and lightweight three-dimensional model of the glass container, wherein the curved surface block feature data of the glass container includes bottle neck and bottle shoulder material optimization data, bottle body material optimization data and bottle bottom material optimization data;
Performing texture material mapping on the bottle neck area and the bottle shoulder area to obtain the bottle neck and bottle shoulder material optimization data;
Performing glossiness material mapping on the bottle body area to obtain the bottle body material optimization data;
Performing transparency material mapping on the bottle bottom area to obtain the bottle bottom material optimization data.

The present invention performs regional surface segmentation on the overall model by using container casting and melting compensation data, which can realize heterogeneous material processing based on the degree of local geometric disturbance and provide fine structural boundary conditions for subsequent multi-dimensional material assignment. Key parameters such as geometric continuity, curvature change rate and normal direction dispersion extracted during the surface segmentation process are uniformly encoded as curved surface block feature data of the glass container, and spatial alignment operation is performed with the original mesh structure, which effectively avoids local dislocation or reconstruction errors of the model topology caused by material mapping. Secondly, texture mapping of the bottleneck and shoulder areas, glossiness mapping of the bottle body area and transparency modeling of the bottle bottom area are implemented based on the feature block data. At the data level, regional material weight matrices reflecting micro-surface roughness, surface reflection coefficient and incident light scattering intensity can be constructed respectively. These matrices are bound to the mesh nodes of the corresponding block areas to generate bottleneck and shoulder material optimization data, bottle body material optimization data and bottle bottom material optimization data, which have local expression capabilities for visual texture, light reflection and light transmission performance respectively. In the data integration stage, the material optimization data of each area realizes boundary stitching and error smoothing compensation between different material maps through mesh model alignment operation, and ensures that the directionality of material texture is consistent with the mesh manifold topology. The finally constructed high-precision and lightweight three-dimensional model of the glass container retains the low-complexity characteristics of the original mesh and presents realistic material responses under various observation conditions, which significantly enhances the data adaptability and expression accuracy of the model in structured light simulation, optical tracking analysis and virtual-real hybrid visualization applications.

Preferably, step S4 includes the following steps:
Step S41: performing glass surface texture evaluation according to the high-precision and lightweight three-dimensional model of the glass container to obtain texture evaluation data of the glass model;
Step S42: performing model generation process evaluation according to the high-precision and lightweight three-dimensional model of the glass container to obtain model generation process evaluation data of the glass model;
Step S43: performing two-dimensional curve evaluation coincidence analysis on the texture evaluation data of the glass model and the model generation process evaluation data of the glass model to obtain model construction coincidence data of the glass model; performing path construction on the model construction coincidence data of the glass model and performing weak point marking to obtain a three-dimensional model construction report of the glass container.

The present invention can extract texture features such as surface roughness distribution, normal fluctuation frequency and optical reflection inhomogeneity from each mesh patch unit by performing glass surface texture evaluation based on the high-precision and lightweight three-dimensional model of the glass container, and map these features to a high-dimensional texture vector space, thereby generating glass model texture evaluation data for reflecting the coverage of the expression ability of the actual surface micro-structure in the modeling process. At the same time, the model generation process evaluation conducts quantitative analysis on the error transfer path in the model construction process by tracking the parameter trajectory formed by each key data node in the model generation chain (such as point cloud fusion density, curvature fitting residual, topology simplification intensity, etc.), and finally generates glass model generation process evaluation data. The above two types of heterogeneous evaluation data are fused through two-dimensional curve evaluation consistency analysis, which can establish a cross mapping between texture quality and generation process in the data space, and extract the sections with local mutation or consistency deviation in the consistency function curve, namely the glass model construction consistency data, which reflects the quantitative consistency between geometric expression ability and modeling reliability. Further, path construction is carried out on the basis of the consistency data, and combined with the model geometric partition information and parameter sensitivity results, the areas with severe texture changes or obvious error amplification are identified and automatically marked as weak points, and finally a three-dimensional model construction report of the glass container is output. At the data level, the report not only provides a traceable sequence of modeling process indicators, but also embeds the coupling analysis results of texture expression and construction logic, providing high-reliability data basis for subsequent structural defect prediction, virtual-real mapping rendering and manufacturing parameter reverse correction.

A multi-modal perception and acquisition module configured to collect information of the lightweight glass container by using a preset multi-modal scanning sensor, collect multi-view visible light images, depth information and structured light projection data, and construct a standard multi-view point cloud data set;

A three-dimensional point cloud fusion and repair module configured to perform multi-modal fusion based on the standard multi-view point cloud data set to obtain multi-modal fusion data of the glass container; perform thin-wall judgment on the multi-modal fusion data of the glass container, and perform thin-wall structure repair to obtain a high-integrity three-dimensional point cloud model;

A model lightweight optimization and material enhancement module configured to perform lightweight mesh optimization based on the high-integrity three-dimensional point cloud model to obtain a low-complexity three-dimensional mesh model; perform global error compensation for container casting and melting on the low-complexity three-dimensional mesh model to obtain container casting and melting compensation data; perform material optimization on the glass contour of the low-complexity three-dimensional mesh model to obtain curved surface block feature data of the glass container; perform model lightweight optimization on the low-complexity three-dimensional mesh model by using the container casting and melting compensation data and the curved surface block feature data of the glass container to obtain a high-precision and lightweight three-dimensional model of the glass container;

An evaluation, analysis and report generation module configured to perform glass surface texture evaluation according to the high-precision and lightweight three-dimensional model of the glass container to obtain texture evaluation data of the glass model; perform model generation process evaluation according to the high-precision and lightweight three-dimensional model of the glass container to obtain model generation process evaluation data of the glass model; construct a full-process path from the texture evaluation data of the glass model and the model generation process evaluation data of the glass model, and perform weak point marking to obtain a three-dimensional model construction report of the glass container.

The multi-modal perception acquisition module of the present system significantly improves the spatial coverage rate and geometric restoration accuracy of point cloud data through joint acquisition of multi-view visible light images, depth information and structured light projection data, especially in dealing with the problem of surface information loss of glass container caused by reflection, light transmission, occlusion and other factors, and can form a structurally complementary data system to construct a multi-view point cloud data set with higher integrity and fineness. Secondly, after fusing data of different modalities, the three-dimensional point cloud fusion and repair module performs geometric consistency judgment based on thin-wall areas common in glass material structures and executes repair algorithms, which effectively fills sparse fragments caused by edges, depressions and transparent areas at the point cloud level, so that the generated high-integrity three-dimensional point cloud model has stronger morphological continuity and data connectivity, laying a solid foundation for subsequent mesh construction. On this basis, the model lightweight optimization and material enhancement module constructs a low-complexity three-dimensional mesh model through topology reconstruction, patch simplification and regional segmentation methods, and superimposes a container casting and melting error compensation mechanism to significantly reduce geometric deviations caused by casting errors or scanning disturbances. Meanwhile, combined with the differences in material characteristics of key areas such as bottleneck, bottle shoulder, bottle body and bottle bottom, local surface optimization and attribute enhancement are carried out to generate curved surface block feature data including local texture, glossiness, transparency and so on, and finally output a high-precision and lightweight three-dimensional model with both visual realism and geometric accuracy. The evaluation analysis and report generation module further conducts closed-loop verification of model quality at the data level, constructs an evaluation path through indicators such as texture contrast, reflectivity distribution and error suppression efficiency, locates weak point areas in the construction process, and forms a three-dimensional model construction report of glass container with multi-dimensional evaluation indicators, providing visual data basis and accurate feedback for subsequent manufacturing, simulation or quality control.

### BRIEF DESCRIPTION OF THE DRAWINGS

FIG. 1 is a schematic flow diagram of steps of a method for generating a three-dimensional model based on a lightweight glass container;

FIG. 2 is a schematic flow diagram of detailed implementation steps of step S4 in FIG. 1;

The realization of the objectives, functional characteristics and advantages of the present invention will be further described in conjunction with the embodiments and with reference to the accompanying drawings.

### DETAILED DESCRIPTION OF THE PREFERRED EMBODIMENTS

The technical method of the present invention will be clearly and completely described below in conjunction with the accompanying drawings. Obviously, the described embodiments are some but not all of the embodiments of the present invention. Based on the embodiments of the present invention, all other embodiments obtained by those skilled in the art without creative efforts shall fall within the protection scope of the present invention.

In addition, the accompanying drawings are merely schematic illustrations of the present invention and are not necessarily drawn to scale. The same reference numerals in the drawings denote the same or similar parts, and thus repeated descriptions thereof will be omitted. Some block diagrams shown in the drawings are functional entities, which do not necessarily correspond to physically or logically independent entities. These functional entities may be implemented in the form of software, or implemented in one or more hardware modules or integrated circuits, or implemented in different network and/or processor methods and/or microcontroller methods.

It should be understood that although the terms “first”, “second”, etc. may be used herein to describe various units, these units should not be limited by these terms. These terms are only used to distinguish one unit from another unit. For example, without departing from the scope of the exemplary embodiments, a first unit may be referred to as a second unit, and similarly, a second unit may be referred to as a first unit. The term “and/or” as used herein includes any and all combinations of one or more of the associated listed items.

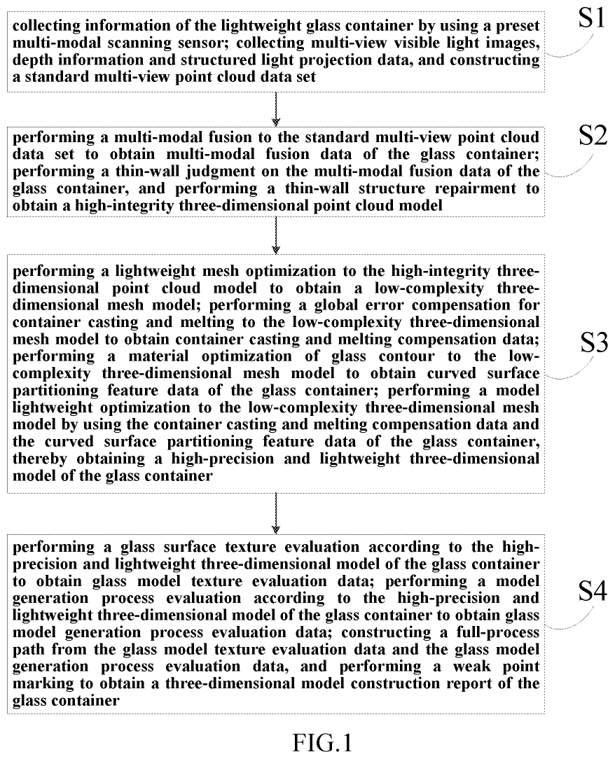

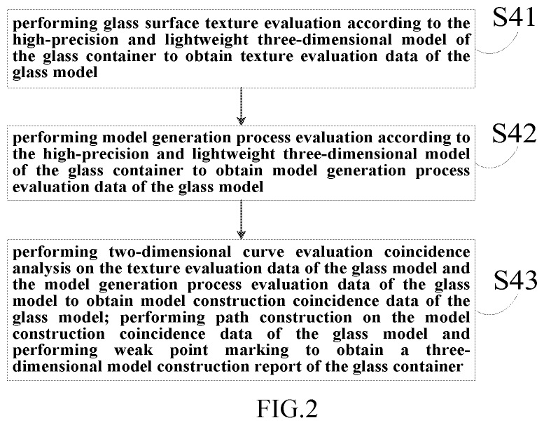

To achieve the above objective, please refer to FIG. 1 to FIG. 2. A method for generating a three-dimensional model based on a lightweight glass container includes the following steps:
Step S1: collecting information of the lightweight glass container by using a preset multi-modal scanning sensor, collecting multi-view visible light images, depth information and structured light projection data, and constructing a standard multi-view point cloud data set;
Step S2: performing multi-modal fusion based on the standard multi-view point cloud data set to obtain multi-modal fusion data of the glass container; performing thin-wall judgment on the multi-modal fusion data of the glass container, and performing thin-wall structure repair to obtain a high-integrity three-dimensional point cloud model;
Step S3: performing lightweight mesh optimization based on the high-integrity three-dimensional point cloud model to obtain a low-complexity three-dimensional mesh model; performing global error compensation for container casting and melting on the low-complexity three-dimensional mesh model to obtain container casting and melting compensation data; performing material optimization on the glass contour of the low-complexity three-dimensional mesh model to obtain curved surface block feature data of the glass container; performing model lightweight optimization on the low-complexity three-dimensional mesh model by using the container casting and melting compensation data and the curved surface block feature data of the glass container to obtain a high-precision and lightweight three-dimensional model of the glass container;
Step S4: performing glass surface texture evaluation according to the high-precision and lightweight three-dimensional model of the glass container to obtain glass model texture evaluation data; performing model generation process evaluation according to the high-precision and lightweight three-dimensional model of the glass container to obtain glass model generation process evaluation data; constructing a full-process path from the glass model texture evaluation data and the glass model generation process evaluation data, and performing weak point marking to obtain a three-dimensional model construction report of the glass container.

In the embodiment of the present invention, referring to FIG. 1, which is a schematic flow diagram of steps of a method for constructing an online industrial analysis big data platform according to the present invention, in the present embodiment, the method for constructing an online industrial analysis big data platform includes the following steps:
Step S1: collecting information of the lightweight glass container by using a preset multi-modal scanning sensor, collecting multi-view visible light images, depth information and structured light projection data, and constructing a standard multi-view point cloud data set;

In the embodiments of the present invention, the core of the involved technology lies in multi-modal three-dimensional perception and data set construction, and the specific process thereof first relies on high-precision and multi-view data collection on the surface of a lightweight glass container. To achieve this goal, the system deploys multi-modal scanning equipment, including a high-resolution visible light camera, an active depth camera and a structured light projection device. By setting a multi-view rotating platform or a multi-camera synchronous acquisition architecture, the system can synchronously obtain response information of the container surface under RGB images, depth maps and structured light interference fringe patterns from different orientations. The RGB images are used to obtain visual features such as surface color and texture, the depth maps capture surface spatial topography information, and the structured light fringe patterns are used to improve the stability and robustness of extracting depth data on the surfaces of smooth, transparent or reflective materials. The collected raw data needs to be subjected to multi-view alignment through a spatial registration algorithm. Typical methods include internal and external parameter solving based on a calibration board, feature point matching such as SIFT/SURF, and fine registration based on the Iterative Closest Point (ICP) algorithm. Subsequently, the data from all views are reconstructed into a three-dimensional point cloud in a unified coordinate system. To ensure the density and coverage of the point cloud, it is necessary to set a reasonable angle interval and overlap rate in the collection stage, and perform operations such as noise filtering, edge correction and redundant point elimination on the collected data, thereby generating a standard multi-view point cloud data set with complete structure, uniform density and consistent coordinates.
Step S2: performing multi-modal fusion based on the standard multi-view point cloud data set to obtain multi-modal fusion data of the glass container; performing thin-wall judgment on the multi-modal fusion data of the glass container, and performing thin-wall structure repair to obtain a high-integrity three-dimensional point cloud model;

In the embodiments of the present invention, the key technology involved lies in performing multi-modal data fusion and fine repair of thin-wall structures based on a standard multi-view point cloud data set, and the core task thereof is to improve the structural integrity and geometric continuity of the three-dimensional point cloud model. First, in the multi-modal fusion stage, it is necessary to perform pixel-wise or point-wise feature mapping between the texture information contained in RGB images, the distance data in depth maps, the optical encoding results obtained by structured light projection and the aligned point cloud data. In specific operations, a projection-back projection model is adopted to transform the image information of each view into a three-dimensional space coordinate system through camera internal parameters and pose matrix, so as to realize the fusion of color-geometry-photometric features. After completing the preliminary fusion, the redundant points, outlier points and cavity areas caused by optical interference in the fusion results are processed. Common algorithms include Statistical Outlier Removal and Voxel Grid Filtering based on statistical features to improve data consistency and uniformity. For thin-wall structure parts, point cloud loss is usually caused by light transmittance, sharp curvature changes or structural occlusion, and surface reconstruction technology needs to be adopted for completion. In the reconstruction process, boundary matching, topological relation reconstruction and surface normal estimation among multi-view point clouds are combined to construct a continuous surface. Meanwhile, interpolation methods such as Poisson Surface Reconstruction or Moving Least Squares (MLS) are introduced to perform high-fitting repair on missing areas, ensuring the complete expression of the reconstructed surface in terms of boundary continuity, normal consistency and geometric stability.

Step S3: performing lightweight mesh optimization based on the high-integrity three-dimensional point cloud model to obtain a low-complexity three-dimensional mesh model; performing global error compensation for container casting and melting on the low-complexity three-dimensional mesh model to obtain container casting and melting compensation data; performing material optimization on the glass contour of the low-complexity three-dimensional mesh model to obtain curved surface block feature data of the glass container; performing model lightweight optimization on the low-complexity three-dimensional mesh model by using the container casting and melting compensation data and the curved surface block feature data of the glass container to obtain a high-precision and lightweight three-dimensional model of the glass container;

In the embodiments of the present invention, the dense point cloud data output in the previous stage is input into a triangular mesh reconstruction algorithm. Common methods include Poisson Surface Reconstruction or Delaunay triangulation technology. By estimating the point cloud normal vector field and constructing a closed surface, conversion of the original point cloud into a structured triangular mesh is realized. Subsequently, to reduce redundant patches and topological complexity, mesh simplification processing needs to be performed, that is, on the basis of maintaining boundary morphology, key feature lines and local curvature changes, the number of patches is reduced. Common simplification methods include the Quadric Error Metrics (QEM) algorithm and Edge Collapse strategy. The simplification process controls the patch merging sequence by defining an error cost function to achieve global complexity minimization. After completing mesh simplification, global error analysis is performed on the geometric deviation introduced by simplification. The point-surface distance or Hausdorff distance between the source point cloud and the mesh model is adopted as the evaluation index, and error compensation is realized through surface fine-tuning and local optimization such as Laplacian smoothing or edge-preserving smoothing algorithm. In the material optimization stage, according to the initial RGB image data and camera projection matrix, color textures are mapped to the triangular mesh surface through methods such as Projective Texture Mapping or Multi-view Texture Blending to solve problems such as uneven illumination and projection distortion, and enhance the continuity and realism of surface materials. The finally output model has low complexity in spatial structure and high resolution and consistency in material expression, forming a high-precision and lightweight three-dimensional representation of the glass container.
step S4: performing glass surface texture evaluation according to the high-precision and lightweight three-dimensional model of the glass container to obtain glass model texture evaluation data; performing model generation process evaluation according to the high-precision and lightweight three-dimensional model of the glass container to obtain glass model generation process evaluation data; constructing a full-process path from the glass model texture evaluation data and the glass model generation process evaluation data, and performing weak point marking to obtain a three-dimensional model construction report of the glass container.

In the embodiments of the present invention, data-driven texture quality analysis and modeling process tracing are performed on the generated high-precision and lightweight three-dimensional model of the glass container, and a full-process path and structural weak point marking mechanism are constructed based on the evaluation results. First, in the texture evaluation stage, based on the texture images mapped on the surface of the mesh model, multiple dimensions of texture quality indicators such as color consistency, texture continuity, illumination balance and local noise level are extracted. Specific methods include using the Gray Level Co-occurrence Matrix (GLCM) to extract texture statistical features such as contrast, energy, correlation and homogeneity, and combining multi-scale edge detection algorithms to detect texture fracture and discontinuous areas, forming a texture defect annotation map, performing mapping comparison with the original RGB images, extracting image-model difference quantitative indicators, and generating glass surface texture evaluation data. Secondly, in the model generation process evaluation link, tracking and analysis are performed on the geometric deviation propagation in each stage of the entire three-dimensional modeling process. The input includes initial point cloud data, simplified mesh data and the final three-dimensional model. Through multi-stage registration error analysis and Hausdorff distance evaluation, the location and magnitude of error accumulation during the modeling process are determined. Meanwhile, process logs and metadata are used to trace changes in point cloud density, responses to simplification thresholds and changes in texture mapping accuracy, and modeling process evaluation data are output. After obtaining the two types of evaluation data, a process path diagram based on two-way indexing of time axis and spatial coordinates is constructed to perform temporal integration on the data processing link. Combined with spatial error heat map analysis, high-error areas and texture anomaly aggregation areas are marked on the surface of the three-dimensional model to realize spatial positioning of weak points. Finally, the evaluation data, path map and annotation information are integrated into a structured model construction report, and various quality indicators and traceability analysis results are output in a standardized format.

Preferably, step S1 includes the following steps:
Step S11: deploying a high-resolution visible light camera with a resolution of more than 20 million pixels and a frame rate of 30 fps and a structured light projector with a wavelength of 450-650 nm and a fringe density of 0.1 mm/line on an annular scanning track, and collecting multi-angle visible light image data and multi-angle structured light projection data at a spatial sampling interval of 0.5 mm;
Step S12: deploying a ToF depth sensor with an accuracy of 0.1 mm and a sampling frequency of 20 Hz in a scanning system, collecting depth information of the glass container, and obtaining glass projection distortion parameters;
Step S13: performing highlight suppression on the multi-angle visible light image data and the multi-angle structured light projection data, and performing refraction compensation by using the glass projection distortion parameters to obtain a glass noise reduction multi-source data set;
Step S14: performing spatial alignment on the glass noise reduction multi-source data set to generate a standard multi-view point cloud data set.

In the embodiments of the present invention, high-resolution visible light image acquisition and structured light projection are realized through the cooperation of visible light cameras (with a resolution of not less than 20 million pixels and a frame rate of 30 fps) and structured light projectors (with a wavelength range of 450-650 nm and a fringe density of 0.1 mm/line) deployed on a circular scanning track, and the sampling interval is set to 0.5 mm to ensure complete image coverage and sufficient spatial detail resolution capability. The projection distortion formed by the structured light fringes on the glass surface will then be modeled and analyzed in the depth compensation stage. In S12, synchronous depth scanning is performed on the target object by deploying a ToF depth sensor (with an accuracy of 0.1 mm and a sampling frequency of 20 Hz) to generate a sequence of multi-frame depth maps, physical measurement data including refraction path changes, object surface deformation responses and glass medium transmission distortion are extracted, and then a refraction distortion parameter model of glass materials is constructed. In S13, aiming at the problem of strong highlight reflection caused by glass materials in visible light images and structured light images, highlight detection algorithms based on color space transformation (such as brightness threshold separation and morphological filtering in the HSV space) and image restoration methods (such as region-based interpolation or edge-preserving smoothing algorithms) are adopted for highlight suppression processing; subsequently, according to the refraction model constructed in S12, refraction compensation is performed on the multi-angle collected images, and methods based on ray-tracing or image re-mapping are used to correct the imaging distortion caused by the light transmittance of glass, and a glass noise-reduced multi-source data set is output. In S14, spatial registration technology is adopted to align the multi-source and multi-view image data to a unified coordinate system. Generally, preliminary registration is first realized through the solution of external parameters of multiple cameras based on a calibration board, and then spatial fusion and error minimization processing are performed on the depth maps generated by image reconstruction and the structured light contour maps by using Iterative Closest Point (ICP) or point cloud registration algorithms based on feature matching, and finally a standard multi-view point cloud data set is formed, laying a data foundation for subsequent three-dimensional model construction and structural analysis.

Preferably, performing multi-modal data fusion based on the standard multi-view point cloud data set in step S2 includes:
Acquiring a glass material parameter library;
Simulating the refraction, reflection and scattering behaviors of light on the glass surface by using the glass material parameter library to generate an optical characteristic mapping table;
Performing point-to-point binding on the optical characteristic mapping table and the standard multi-view point cloud data set to generate physically enhanced point cloud data;
Inputting the physically enhanced point cloud data into a differentiable renderer to perform L1 loss and SSIM loss calculations between a rendered image and a real visible light image, so as to generate multi-modal fusion data of the glass container, wherein the weights of the L1 loss and the SSIM loss are 0.7 and 0.3 respectively.

In the embodiments of the present invention, the technical means described in this section cover multiple key steps such as optical modeling of glass materials, binding of point clouds to physical properties, differentiable rendering, and point cloud calibration and optimization based on image reconstruction errors, and the core goal thereof is to introduce real physical characteristics on the basis of a standard multi-view point cloud data set to improve the optical consistency and spatial accuracy of three-dimensional data. First, physical property data including refractive index, reflectivity, scattering coefficient, absorption coefficient, dispersion parameters and the like are collected by acquiring a glass material parameter library, and such data can be derived from actual measurements or optical simulation models, for example, modeling and analyzing the propagation path and energy loss of light in different wavebands based on the Fresnel equation and Rayleigh scattering theory. Subsequently, according to various properties provided in the material parameter library, path tracing or Monte Carlo light propagation simulation methods are adopted to simulate the refraction, reflection and scattering behaviors of light on the glass interface, generating an optical characteristic mapping table which takes spatial coordinates as an index and records information such as light propagation direction, intensity attenuation coefficient and reflectivity distribution of each point under specific observation angles and illumination conditions. Next, a point-to-point binding operation is performed between the optical characteristic mapping table and each spatial point in the standard multi-view point cloud data set, that is, attaching the corresponding physical and optical property vector to each point cloud coordinate point, thereby forming physically enhanced point cloud data. On this basis, a Differentiable Renderer is introduced, the physically enhanced point cloud is input into the renderer to synthesize corresponding pseudo-images, and pixel-level comparison is performed between the pseudo-images and actually collected visible light images, and point cloud optimization is carried out by constructing an image reconstruction loss function. The loss function consists of two parts, namely L1 loss (absolute error) and SSIM (structural similarity index), which measure the image pixel intensity difference and structural texture similarity respectively, and the weighted ratio thereof is set to 0.7 and 0.3, so as to retain structural consistency while ensuring brightness matching. Finally, the backpropagation mechanism is used to optimize point cloud coordinates or attached attribute vectors, and multi-modal fusion and calibration of the physically enhanced point cloud are realized under the framework of the differentiable renderer, obtaining calibrated multi-modal fused point cloud data that is more consistent with real visual performance.

Preferably, performing thin-wall structure repair in step S2 includes:
Performing prediction for thin-wall areas less than 2 mm based on the multi-modal fusion data of the glass container to generate a predicted glass thickness distribution;
Inputting the predicted glass thickness distribution as a constraint condition into a Poisson surface reconstruction algorithm, wherein the depth of the Poisson surface reconstruction algorithm is 10 and the weight is 0.5, to obtain vertex density data of the glass curved surface mesh;
Performing iterative Poisson reconstruction parameter adjustment on the vertex density data of the glass curved surface mesh, and performing three-dimensional mesh model construction to obtain a high-integrity three-dimensional point cloud model.

In the embodiments of the present invention, the technical means described in this section mainly focus on thickness prediction of glass thin-wall areas based on calibrated multi-modal fused point cloud data, constraint-driven Poisson Surface Reconstruction, and iterative optimization of the mesh construction process, and the core lies in integrating geometric features, physical characteristics and surface reconstruction algorithms to realize the construction of a three-dimensional point cloud model with high precision and good continuity. First, based on the calibrated fused point cloud data, it is necessary to predict the spatial thickness of the glass container surface, where areas with a thickness less than 2 mm are defined as thin-wall structures. The prediction process can be modeled through local curvature analysis, normal distribution change rate and point-to-point Euclidean distance evaluation methods, supplemented by thickness estimation algorithms based on voxel projection or bilateral difference interpolation, so as to form a high-resolution thickness distribution map. The glass predicted thickness distribution data is then used as input of constraint conditions in the Poisson Surface Reconstruction process. Specifically, a weighted Poisson Surface Reconstruction algorithm is adopted, and the depth parameter is set to 10 to ensure that the reconstruction captures the detail level, while the weight is set to 0.5 to achieve a balance between point cloud density and reconstruction smoothness. The algorithm constructs an octree voxel structure for solving the Poisson equation, converts the normal field of the point cloud into a scalar field gradient field, thereby inversely deriving an implicit surface function, and generates an initial surface mesh from the isosurface of the function. After preliminarily obtaining the vertex density data of the surface mesh, the Poisson reconstruction parameters are further iteratively optimized, that is, on the premise of maintaining the structural continuity of the initial solution, the octree depth, interpolation radius and regularization term weight are adjusted to minimize the geometric deviation between the actual point cloud and the reconstructed surface. The optimization process is usually guided by a local residual function convergence criterion and a mesh reconstruction error feedback mechanism. Finally, through topological reconstruction of mesh connection for the optimized density data, combined with a triangulation algorithm and a boundary reprojection strategy, the construction of the three-dimensional mesh model is completed, forming a glass three-dimensional point cloud model with high structural integrity and good thickness continuity, which provides data support for subsequent steps such as geometric compression, surface feature analysis and material mapping.

Preferably, performing lightweight mesh optimization based on the high-integrity three-dimensional point cloud model in step S3 includes:
Performing gaussian curvature threshold judgment and sensitivity analysis on the high-integrity three-dimensional point cloud model to obtain sensitivity analysis data of the three-dimensional point cloud model, wherein the Gaussian curvature threshold is less than 0.01/mm²;
Performing scratch and seam area identification by using the sensitivity analysis data of the three-dimensional point cloud model, and marking the data as physical characteristic exemption data;
Performing mesh reduction on the high-integrity three-dimensional point cloud model based on the physical characteristic exemption data to obtain a mesh area reduction model, wherein the reduction rate of mesh reduction is 20%-50%;
Performing mesh topology optimization on the mesh area reduction model to obtain a low-complexity three-dimensional mesh model.

In the embodiments of the present invention, the technical means described in this section focus on a series of continuous operations at the data level, including local curvature feature extraction, sensitive area identification, exemption area marking, mesh reduction and topological structure optimization for the high-integrity three-dimensional point cloud model, aiming to maintain geometric stability on the premise of simplifying complex structures. First, Gaussian curvature calculation is performed on the three-dimensional point cloud model, and the principal curvature derivative formula K=is adopted, where and are the maximum and minimum principal curvatures at each point respectively. To avoid the interference of abnormal noise on curvature, a local surface approximation technology based on normal fitting is adopted, and curvature values are stably solved through a weighted least squares surface fitting algorithm on the basis of point-normal pairs. All areas with Gaussian curvature less than 0.01 are determined as flat curvature areas, their response capability under structural degradation or disturbance scenarios is evaluated through sensitivity analysis, and sensitivity coefficients are assigned to these areas by using an evaluation method based on the intensity distribution of point position disturbance responses. Subsequently, combined with geometric texture change information, areas with significant sensitivity characteristics and structural mutations (such as scratches or joints) are located, and these areas are marked as “physical characteristic exemption data”, which means that they need to be retained in subsequent reduction to maintain structural identifiability. Then, on the premise of not affecting the integrity of exemption areas, mesh reduction operation is performed. The reduction strategy is regulated according to point density redundancy and normal distribution uniformity, and the reduction rate is controlled between 20% and 50% of the total number of overall meshes. In the reduction process, a patch error control function and a triangular face simplification algorithm (such as the QEM algorithm) are adopted to maintain geometric approximation. Finally, mesh topology optimization is implemented on the basis of the mesh area reduction model after reduction. Operations such as edge collapse, face merging and point repositioning are carried out to eliminate topological redundancy and improve the quality of connectivity structure, ensuring that the simplified mesh achieves better patch distribution balance and shape expression stability under the original geometric constraints, so as to obtain a low-complexity three-dimensional mesh model, which lays a data foundation for subsequent material mapping and precision compensation stages.

Preferably, performing mesh topology optimization on the mesh area reduction model in Step S3 includes:
Performing edge collapse error optimization on the mesh area reduction model to obtain edge collapse optimization data;
Performing mesh manifold integrity verification according to the edge collapse optimization data to obtain glass manifold integrity data;
Performing mesh topology structure construction by using the glass manifold integrity data, and performing non-manifold edge and isolated vertex verification by using Euler's formula to obtain a glass container mesh topology structure;
Performing low-complexity optimization on the glass container mesh topology structure and the mesh area reduction model to obtain a low-complexity three-dimensional mesh model.

In the embodiments of the present invention, the technical means mainly involve geometric error control and topological consistency construction of the reduced mesh model, and are specifically carried out from four data processing links including edge collapse error measurement, mesh manifoldness verification, topological structure reconstruction and complexity control. First, for the mesh area reduction model, an edge collapse optimization method based on the principle of local geometric deviation minimization is adopted. By calculating the Quadric Error Metrics (QEM) of each candidate collapsing edge, the normal vector change, angle deviation and position fitting error between adjacent faces after edge collapse are evaluated, so as to generate edge collapse optimization data, which records the numerical impact of each collapsing operation on the geometric reconstruction of the original mesh surface in the local coordinate system. Subsequently, based on the edge collapse optimization data, the integrity verification of the manifoldness of the reduced model is performed. A mesh topology graph is constructed by using a face-edge-point three-dimensional adjacency list structure, and all structural nodes with non-manifold edges (shared by three or more faces) and isolated vertices (not associated with any faces) are identified. Then glass manifoldness integrity data is generated accordingly. Next, the mesh topological structure is reconstructed by using the above integrity data. Connected regions and closed boundaries are identified through depth-first search (DFS) and boundary tracking algorithms to ensure that the adjacency of all faces meets topological consistency. Meanwhile, Euler's formula is introduced for global structural verification. The number of vertices, edges and faces is calculated, and combined with the Euler characteristic, the mesh is verified whether it is a closed polyhedron structure, so as to detect and locate topological anomalies from a topological perspective. Finally, combined with the reconstructed mesh topological structure and the original reduced model, low-complexity optimization processing is performed by means of simplifying patch layout, merging coplanar triangles, sparsifying dense vertex regions and other methods, the number of patches and mesh density are controlled to achieve sparse expression while retaining structural boundaries, and finally a low-complexity three-dimensional mesh model with both topological closure, manifold consistency and concise data structure is formed.

Preferably, performing global error compensation and material optimization on the low-complexity three-dimensional mesh model in step S3 includes:
Acquiring measured data of the glass container;
Performing geometric node extraction of the glass container based on the low-complexity three-dimensional mesh model;
Performing node error analysis by using the geometric node extraction of the glass container and the measured data of the glass container to obtain node comparison and analysis data of the glass container;
Performing deviation compensation according to the node comparison and analysis data of the glass container to obtain container casting and melting compensation data.

In the embodiments of the present invention, the technical means mainly include comparative analysis between measured data and the low-complexity three-dimensional mesh model, error compensation, material optimization and other steps, focusing on the entire process of geometric node extraction, error analysis, deviation correction and model precision improvement. First, the obtained measured data of the glass container usually includes specific geometric information such as size, shape and position, which is generally acquired by high-precision three-dimensional scanning or other measurement technologies (such as laser scanning, structured light, ToF sensors, etc.). Based on the low-complexity three-dimensional mesh model, geometric node extraction algorithms (such as vertex extraction, boundary tracking, etc.) are adopted to accurately locate and extract key structural units (such as nodes, edges, faces) in the mesh model. Next, by using the comparison between the extracted geometric nodes and the measured data, node error analysis is performed. Geometric error measurement methods such as Euclidean distance and least squares fitting are adopted to calculate the deviation of each geometric node in dimensions such as position, shape and normal direction. Through such analysis, glass container node comparison and analysis data are generated, which record the error distribution between the model nodes and the measured data, reflecting the difference between the model precision and the actual object. Based on the error data, further deviation compensation is performed. Common methods include node position adjustment, normal direction correction and local geometric repair through the least squares method, thereby generating container casting and melting compensation data. This process corrects the model in terms of geometric structure, reduces the deviation from the measured data, and optimizes the accuracy of the three-dimensional model. Finally, the low-complexity three-dimensional mesh model is subjected to material optimization by using the error balance data. The goal of material optimization is to make the material properties of the model (such as density, stiffness, texture, etc.) more consistent with the physical characteristics of the actual object. The optimization process is usually carried out by means of material property mapping, optical characteristic adjustment and alignment with the measured data, and finally a high-precision and lightweight three-dimensional model of the glass container is obtained. The optimization not only improves the geometric accuracy of the model, but also ensures the similarity between the material characteristics and the actual glass container, so that the final model meets high precision standards in various aspects.

Preferably, performing material optimization on the low-complexity three-dimensional mesh model by using the container casting and melting compensation data includes:
Performing curved surface block division on a bottle neck area, a bottle shoulder area, a bottle body area and a bottle bottom area by using the container casting and melting compensation data to obtain curved surface block feature data of the glass container; performing mesh model alignment on the curved surface block feature data of the glass container to obtain a high-precision and lightweight three-dimensional model of the glass container, wherein the curved surface block feature data of the glass container includes bottle neck and bottle shoulder material optimization data, bottle body material optimization data and bottle bottom material optimization data;
Performing texture material mapping on the bottle neck area and the bottle shoulder area to obtain the bottle neck and bottle shoulder material optimization data;
Performing glossiness material mapping on the bottle body area to obtain the bottle body material optimization data;
Performing transparency material mapping on the bottle bottom area to obtain the bottle bottom material optimization data.

In the embodiments of the present invention, the focus is on the collaborative integration of error balance application, surface block processing, mesh alignment mechanism and regional material optimization technology for glass container in different functional areas, aiming to achieve geometric accuracy control while taking into account the visual authenticity and data load controllability of the model, so as to generate a three-dimensional model with the characteristics of high precision, high fidelity and lightweight. First, the system introduces error balance data as the basis for geometric correction, and effectively improves surface continuity and structural stability through statistical regression and local compensation for node deviations in the original three-dimensional model. On this basis, a differentiated surface blocking strategy is implemented for the four key areas of the glass container, namely the bottleneck, shoulder, body and bottom. The blocking process integrates local Gaussian curvature analysis, principal direction normal vector distribution analysis and surface slope gradient identification methods to systematically identify and classify each area in terms of geometric shape, curvature change and optical characteristics, realizing physical characteristic-driven block feature extraction. Each surface block not only contains its corresponding geometric information (such as curvature, thickness distribution, connection boundary conditions, etc.), but also carries local surface texture parameters, material reaction characteristics and topological structure constraints within the area. The multi-dimensional feature data serves as alignment input and plays a key role in the subsequent mesh model alignment stage. The mesh alignment process adopts a combination of local feature point matching algorithm and global rigid body transformation optimization to ensure seamless transition between different areas in terms of vertex connection, boundary smoothness and normal continuity, thus constructing a geometrically accurate and topologically reasonable basic three-dimensional framework. After the construction of the structural framework is completed, the system further implements refined texture mapping optimization for each functional area. Due to the drastic structural transition and the usual bearing of external identification marks in the bottleneck and shoulder areas, texture mapping enhancement is adopted. Based on the image texture mapping algorithm and transparency/refractive index control function, high-detail texture reproduction is carried out for these areas, so that the surface texture can truly reflect the microscopic characteristics and processing traces of the glass; the body area adopts high dynamic gloss mapping technology to simulate the ratio of specular reflection to diffuse reflection under different illumination angles, improving its smoothness performance and visual response consistency; the bottom area uses transparency control mapping technology to accurately simulate its light transmittance, light intensity attenuation caused by thickness and internal reflection characteristics, thereby enhancing the authenticity of its optical performance. During the entire material mapping process, parameter configuration is carried out based on the region-specific feature database to ensure that each area can reflect material perception and visual effects consistent with the real object during rendering. In summary, the present invention exerts synergistic efforts in multiple aspects including error compensation, structural blocking, geometric alignment and regional material mapping. The generated high-precision and lightweight three-dimensional glass container model not only has micron-level precision in geometric restoration, but also can realistically restore the reflective, light-transmitting and texture detail characteristics of real glass in visual reconstruction, which greatly improves the application adaptability and authenticity of the model in multiple scenarios such as virtual display, industrial design and digital manufacturing.

As an example of the present invention, referring to FIG. 2, in the present example, the step S4 includes:
Step S41: performing glass surface texture evaluation according to the high-precision and lightweight three-dimensional model of the glass container to obtain texture evaluation data of the glass model;
Step S42: performing model generation process evaluation according to the high-precision and lightweight three-dimensional model of the glass container to obtain model generation process evaluation data of the glass model;
Step S43: performing two-dimensional curve evaluation coincidence analysis on the texture evaluation data of the glass model and the model generation process evaluation data of the glass model to obtain model construction coincidence data of the glass model; performing path construction on the model construction coincidence data of the glass model and performing weak point marking to obtain a three-dimensional model construction report of the glass container.

In the embodiments of the present invention, the technical content involves surface texture evaluation based on the high-precision and lightweight three-dimensional model, model generation process evaluation, and generation of a complete glass container three-dimensional model construction report through data analysis and matching. First, texture evaluation is performed according to the high-precision three-dimensional model of the glass container. This process conducts detailed analysis on the surface features of the model to evaluate the authenticity and accuracy of surface details. Texture evaluation data usually includes measurement and verification of attributes such as surface gloss, transparency and roughness. The evaluation data can reflect the quality of the glass container surface, thereby providing a basis for subsequent material optimization and rendering. Then, evaluation of the model generation process also needs to be performed according to the three-dimensional model. The purpose of this evaluation is to detect errors, defects or deficiencies occurring during the three-dimensional modeling process. Model generation process evaluation data mainly includes accuracy analysis of different algorithm applications during modeling, evaluation of surface smoothness, error tracking during geometric construction and the like, all of which reflect the stability and accuracy of model generation. Two-dimensional curve evaluation consistency analysis is performed on the texture evaluation data and the generation process evaluation data, which is a process of integrating and comparing the evaluation data. Through two-dimensional curve evaluation, the consistency of the model surface in different evaluation dimensions, namely the geometric accuracy and texture matching degree of the model, can be clarified, thereby revealing whether deviations exist during the actual model construction process. Combined with the data, glass model construction consistency data is generated to further optimize the accuracy and quality of model generation. On this basis, path construction and weak point marking are carried out, and potential problem areas of the model such as local geometric defects, texture mismatches or error areas during the construction process are identified through technical means, and finally a glass container three-dimensional model construction report is formed. The report not only records key data and problem areas during the model construction process in detail, but also provides data support and basis for subsequent improvement and optimization. The entire process continuously refines and optimizes the model through data-driven analysis and evaluation, ensuring that the finally generated three-dimensional model of the glass container has high precision and high consistency in various aspects.

Particularly importantly, step S41 includes the following steps:
Step S411: extract texture images according to the UV maps of the high-precision and lightweight three-dimensional model of the glass container, and calculate texture contrast by using the gray level co-occurrence matrix to obtain texture contrast data of the glass model;
Step S412: perform illumination angle simulation according to the texture contrast data of the glass model to obtain a simulated reflectance distribution map;
Step S413: calculate the root mean square of the measured reflectance based on the simulated reflectance distribution map to obtain texture evaluation data of the glass model.

In the embodiments of the present invention, by introducing UV map texture image analysis based on the high-precision and lightweight three-dimensional model, a multi-level data-driven method for visual quality evaluation of glass container is constructed. By extracting the UV map of the model and constructing the corresponding two-dimensional texture image, and then calculating the texture contrast based on the Gray Level Co-occurrence Matrix (GLCM), the method not only realizes quantitative modeling of the distribution law of surface textures, but also converts originally subjective visual attributes into quantifiable statistical feature data, thereby obtaining texture contrast data of the glass model and laying a foundation for subsequent illumination simulation. The texture contrast data is used to drive the illumination angle simulation process. By setting different incident angles and observation angles, the changes in reflectance of the glass surface under various illumination conditions are calculated, and a simulated reflectance distribution map is generated. This map not only reflects the optical response of texture details in visual performance, but also reveals the reflection behavior characteristics of the model under different material distributions. Through root mean square error analysis between the simulated reflectance distribution map and the reflectance data of measured glass samples, texture evaluation data of the glass model is obtained. The data has strong accuracy discrimination ability and texture simulation verification value, and can effectively evaluate the accuracy of the current model in terms of apparent detail expression and optical consistency. The entire process starts from the two-dimensional features of the texture image, and forms a complete data chain through illumination simulation and error evaluation, so that the surface texture of the three-dimensional model of the glass container not only maintains consistency in geometry, but also has a high degree of restoration ability for real optical characteristics at the visual performance level, thereby providing solid data support and evaluation basis for the application of the model in scenarios such as digital rendering, industrial inspection and virtual display.

Particularly importantly, step S42 includes the following steps:
Step S421: calculate the initial point cloud missing rate of the thin-wall area according to the high-precision and lightweight three-dimensional model of the glass container, and mark the unrepaired coordinates to obtain thin-wall unrepaired coordinate data;
Step S422: perform evaluation of the mesh optimization stage on the thin-wall unrepaired coordinate data to obtain mesh optimization stage data;
Step S423: conduct global error suppression efficiency analysis on the mesh optimization stage data, and perform model generation process evaluation to obtain glass model generation process evaluation data.

In the embodiments of the present invention, Steps S421 to S423 in this embodiment construct a three-dimensional modeling process evaluation path for glass container based on the point cloud missing monitoring and error suppression feedback mechanism, focusing on solving the problems of structural integrity and error diffusion of thin-wall areas during the modeling process. Specifically, first, the high-precision and lightweight three-dimensional model of the glass container is used to calculate the initial point cloud missing rate of typical thin-wall areas, identify the point cloud data loss problems caused by scanning occlusion, curvature mutation or reflectivity change, and perform spatial annotation on the unrepaired coordinate positions to generate thin-wall unrepaired coordinate data, thereby constructing an initial defect localization mechanism for weak modeling areas at the point cloud level. Based on the unrepaired coordinate data, Step S422 further proceeds to the mesh optimization stage evaluation, performs quantitative analysis on the structural recovery of thin-wall areas by comparing data dimensions such as geometric continuity before and after optimization, mesh density changes and topological consistency indicators, and obtains mesh optimization stage data. Such data not only reflects the repair capability of mesh reconstruction for missing point compensation, but also lays an analysis foundation for subsequent error control. Then, with the mesh optimization stage data as input, combined with the error accumulation in the global modeling path, error suppression efficiency analysis is carried out, and an evaluation system is constructed by using multi-dimensional indicators such as root mean square deviation, normal offset statistics and mesh volume error ratio, and finally glass model generation process evaluation data is formed. The data can be used to systematically reveal the impact of different links in the modeling process on the recovery of thin-wall structures and overall geometric accuracy, and has the functional value of finely controlling modeling quality and tracing error sources. Therefore, this technical path opens up an evaluation closed loop from micro data defects to macro modeling quality through key steps such as point cloud missing localization, mesh optimization evaluation and error suppression analysis, and improves the process interpretability and modeling reliability of the glass container three-dimensional modeling system.

In this specification, a three-dimensional model generation system based on a lightweight glass container is provided, which is used for executing the above-mentioned three-dimensional model generation method, based on a lightweight glass container, and the three-dimensional model generation system based on a lightweight glass container includes:
A multi-modal perception and acquisition module configured to collect information of the lightweight glass container by using a preset multi-modal scanning sensor, collect multi-view visible light images, depth information and structured light projection data, and construct a standard multi-view point cloud data set;
A three-dimensional point cloud fusion and repair module configured to perform multi-modal fusion based on the standard multi-view point cloud data set to obtain multi-modal fusion data of the glass container; perform thin-wall judgment on the multi-modal fusion data of the glass container, and perform thin-wall structure repair to obtain a high-integrity three-dimensional point cloud model;
A model lightweight optimization and material enhancement module configured to perform lightweight mesh optimization based on the high-integrity three-dimensional point cloud model to obtain a low-complexity three-dimensional mesh model; perform global error compensation for container casting and melting on the low-complexity three-dimensional mesh model to obtain container casting and melting compensation data; perform material optimization on the glass contour of the low-complexity three-dimensional mesh model to obtain curved surface block feature data of the glass container; perform model lightweight optimization on the low-complexity three-dimensional mesh model by using the container casting and melting compensation data and the curved surface block feature data of the glass container to obtain a high-precision and lightweight three-dimensional model of the glass container;
An evaluation, analysis and report generation module configured to perform glass surface texture evaluation according to the high-precision and lightweight three-dimensional model of the glass container to obtain texture evaluation data of the glass model; perform model generation process evaluation according to the high-precision and lightweight three-dimensional model of the glass container to obtain model generation process evaluation data of the glass model; construct a full-process path from the texture evaluation data of the glass model and the model generation process evaluation data of the glass model, and perform weak point marking to obtain a three-dimensional model construction report of the glass container.

Therefore, from any point of view, the embodiments should be regarded as illustrative and non-restrictive. The scope of the present invention is defined by the appended claims rather than the above description, and thus it is intended to cover all changes that fall within the meaning and scope of the equivalent elements of the application documents.

The above descriptions are merely specific implementation manners of the present invention, enabling those skilled in the art to understand or implement the present invention. Various modifications to these embodiments will be obvious to those skilled in the art. The general principles defined herein may be implemented in other embodiments without departing from the spirit or scope of the present invention. Therefore, the present invention will not be limited to the embodiments shown herein, but is to conform to the widest scope consistent with the principles and novel features disclosed herein.

What is claimed is:

1. A three-dimensional model generation method, based on lightweight glass container, wherein the method comprises the following steps:
step S1: collecting information of the lightweight glass container by using a preset multi-modal scanning sensor; collecting multi-view visible light images, depth information and structured light projection data, and constructing a standard multi-view point cloud data set;
step S2: performing a multi-modal fusion to the standard multi-view point cloud data set to obtain multi-modal fusion data of the glass container; performing a thin-wall judgment on the multi-modal fusion data of the glass container, and performing a thin-wall structure repairment to obtain a high-integrity three-dimensional point cloud model;
step S3: performing a lightweight mesh optimization to the high-integrity three-dimensional point cloud model to obtain a low-complexity three-dimensional mesh model; performing a global error compensation for container casting and melting to the low-complexity three-dimensional mesh model to obtain container casting and melting compensation data; performing a material optimization of glass contour to the low-complexity three-dimensional mesh model to obtain curved surface partitioning feature data of the glass container; performing a model lightweight optimization to the low-complexity three-dimensional mesh model by using the container casting and melting compensation data and the curved surface partitioning feature data of the glass container, thereby obtaining a high-precision and lightweight three-dimensional model of the glass container;
step S4: performing a glass surface texture evaluation according to the high-precision and lightweight three-dimensional model of the glass container to obtain glass model texture evaluation data; performing a model generation process evaluation according to the high-precision and lightweight three-dimensional model of the glass container to obtain glass model generation process evaluation data; constructing a full-process path from the glass model texture evaluation data and the glass model generation process evaluation data, and performing a weak point marking to obtain a three-dimensional model construction report of the glass container.

2. The three-dimensional model generation method, based on lightweight glass container according to claim 1, wherein step S1 comprises the following steps:
step S11: deploying a high-resolution visible light camera with a resolution of more than 20 million pixels and a frame rate of 30 fps and a structured light projector with a wavelength of 450-650 nm and a fringe density of 0.1 mm/line on an annular scanning track, and collecting multi-angle visible light image data and multi-angle structured light projection data at a spatial sampling interval of 0.5 mm;
step S12: deploying a ToF depth sensor with an accuracy of 0.1 mm and a sampling frequency of 20 Hz in a scanning system; collecting depth information of the glass container, and obtaining glass projection distortion parameters;
step S13: performing a highlight suppression on the multi-angle visible light image data and the multi-angle structured light projection data, and performing refraction compensation by using the glass projection distortion parameters to obtain a glass noise reduction multi-source data set;
step S14: performing spatial alignment on the glass noise reduction multi-source data set to generate a standard multi-view point cloud data set.

3. The three-dimensional model generation method, based on lightweight glass container according to claim 1, wherein the performance of multi-modal data fusion based on the standard multi-view point cloud data set in step S2 comprises:
acquiring a glass material parameter library;
simulating the refraction, reflection and scattering behaviors of light on the glass surface by using the glass material parameter library to generate an optical characteristic mapping table;
performing point-to-point binding on the optical characteristic mapping table and the standard multi-view point cloud data set to generate physically enhanced point cloud data;
inputting the physically enhanced point cloud data into a differentiable renderer to perform L1 loss and SSIM loss calculations between a rendered image and a real visible light image, so as to generate multi-modal fusion data of the glass container, wherein the weights of the L1 loss and the SSIM loss are 0.7 and 0.3 respectively.

4. The three-dimensional model generation method, based on lightweight glass container according to claim 1, wherein the performance of thin-wall structure repair in step S2 comprises:
performing prediction for thin-wall areas less than 2 mm based on the multi-modal fusion data of the glass container to generate a predicted glass thickness distribution;
inputting the predicted glass thickness distribution as a constraint condition into a Poisson surface reconstruction algorithm, wherein the depth of the Poisson surface reconstruction algorithm is 10 and the weight is 0.5, to obtain vertex density data of the glass curved surface mesh;
performing iterative Poisson reconstruction parameter adjustment on the vertex density data of the glass curved surface mesh, and performing three-dimensional mesh model construction to obtain a high-integrity three-dimensional point cloud model.

5. The three-dimensional model generation method, based on lightweight glass container according to claim 1, wherein the performance of lightweight mesh optimization based on the high-integrity three-dimensional point cloud model in step S3 comprises:
performing Gaussian curvature threshold judgment and sensitivity analysis on the high-integrity three-dimensional point cloud model to obtain sensitivity analysis data of the three-dimensional point cloud model, wherein the Gaussian curvature threshold is less than 0.01/mm²;
performing scratch and seam area identification by using the sensitivity analysis data of the three-dimensional point cloud model, and marking the data as physical characteristic exemption data;
performing mesh reduction on the high-integrity three-dimensional point cloud model based on the physical characteristic exemption data to obtain a mesh area reduction model, wherein the reduction rate of mesh reduction is 20%-50%;
performing mesh topology optimization on the mesh area reduction model to obtain a low-complexity three-dimensional mesh model.

6. The three-dimensional model generation method, based on lightweight glass container according to claim 5, wherein the performance of mesh topology optimization on the mesh area reduction model in step S3 comprises:
performing edge collapse error optimization on the mesh area reduction model to obtain edge collapse optimization data;
performing mesh manifold integrity verification according to the edge collapse optimization data to obtain glass manifold integrity data;
performing mesh topology structure construction by using the glass manifold integrity data, and performing non-manifold edge and isolated vertex verification by using Euler's formula to obtain a glass container mesh topology structure;
performing low-complexity optimization on the glass container mesh topology structure and the mesh area reduction model to obtain a low-complexity three-dimensional mesh model.

7. The three-dimensional model generation method, based on lightweight glass container according to claim 1, wherein the performance of global error compensation for container casting and melting on the low-complexity three-dimensional mesh model in step S3 comprises:
acquiring measured data of the glass container;
performing geometric node extraction of the glass container based on the low-complexity three-dimensional mesh model;
performing node error analysis by using the geometric node extraction of the glass container and the measured data of the glass container to obtain node comparison and analysis data of the glass container;
performing deviation compensation according to the node comparison and analysis data of the glass container to obtain container casting and melting compensation data.

8. The three-dimensional model generation method, based on lightweight glass container according to claim 1, wherein the performance of material optimization on the glass contour of the low-complexity three-dimensional mesh model comprises:
performing curved surface block division on a bottle neck area, a bottle shoulder area, a bottle body area and a bottle bottom area by using the container casting and melting compensation data to obtain curved surface block feature data of the glass container; performing mesh model alignment on the curved surface block feature data of the glass container to obtain a high-precision and lightweight three-dimensional model of the glass container, wherein the curved surface block feature data of the glass container comprises bottle neck and bottle shoulder material optimization data, bottle body material optimization data and bottle bottom material optimization data;
performing texture material mapping on the bottle neck area and the bottle shoulder area to obtain the bottle neck and bottle shoulder material optimization data;
performing glossiness material mapping on the bottle body area to obtain the bottle body material optimization data;
performing transparency material mapping on the bottle bottom area to obtain the bottle bottom material optimization data.

9. The three-dimensional model generation method, based on lightweight glass container according to claim 1, wherein step S4 comprises the following steps:
step S41: performing glass surface texture evaluation according to the high-precision and lightweight three-dimensional model of the glass container to obtain texture evaluation data of the glass model;
step S42: performing model generation process evaluation according to the high-precision and lightweight three-dimensional model of the glass container to obtain model generation process evaluation data of the glass model;
step S43: performing two-dimensional curve evaluation coincidence analysis on the texture evaluation data of the glass model and the model generation process evaluation data of the glass model to obtain model construction coincidence data of the glass model; performing path construction on the model construction coincidence data of the glass model and performing weak point marking to obtain a three-dimensional model construction report of the glass container.

10. A three-dimensional model generation system based on lightweight glass container, wherein the system is configured to execute the three-dimensional model generation method, based on lightweight glass container according to claim 1, and the three-dimensional model generation system based on lightweight glass container comprises:
a multi-modal perception and acquisition module, configured to collect information of the lightweight glass container by using a preset multi-modal scanning sensor, collect multi-view visible light images, depth information and structured light projection data, and construct a standard multi-view point cloud data set;
a three-dimensional point cloud fusion and repair module configured to perform multi-modal fusion based on the standard multi-view point cloud data set to obtain multi-modal fusion data of the glass container; perform thin-wall judgment on the multi-modal fusion data of the glass container, and perform thin-wall structure repair to obtain a high-integrity three-dimensional point cloud model;
a model lightweight optimization and material enhancement module configured to perform lightweight mesh optimization based on the high-integrity three-dimensional point cloud model to obtain a low-complexity three-dimensional mesh model; perform global error compensation for container casting and melting on the low-complexity three-dimensional mesh model to obtain container casting and melting compensation data; perform material optimization on the glass contour of the low-complexity three-dimensional mesh model to obtain curved surface block feature data of the glass container; perform model lightweight optimization on the low-complexity three-dimensional mesh model by using the container casting and melting compensation data and the curved surface block feature data of the glass container to obtain a high-precision and lightweight three-dimensional model of the glass container;
an evaluation, analysis and report generation module configured to perform glass surface texture evaluation according to the high-precision and lightweight three-dimensional model of the glass container to obtain texture evaluation data of the glass model; perform model generation process evaluation according to the high-precision and lightweight three-dimensional model of the glass container to obtain model generation process evaluation data of the glass model; construct a full-process path from the texture evaluation data of the glass model and the model generation process evaluation data of the glass model, and perform weak point marking to obtain a three-dimensional model construction report of the glass container.
